(19) United States
(12) Patent Application Publication
(10) Pub. No.: US 2010/0156119 A1
(43) Pub. Date: Jun. 24, 2010

(54) ADJUSTABLE GATE LATCH ASSEMBLY FOR FENCE GATE

(75) Inventors: Frederick Harold Mueller, San Angelo, TX (US); Douglas Ray Diebold, Fort Gibson, OK (US); Michael Alvis Lee, San Angelo, TX (US)

Correspondence Address: STORM LLP, BANK OF AMERICA PLAZA, 901 MAIN STREET, SUITE 7100, DALLAS, TX, 75202, US

(73) Assignee: Mueller Metals, Inc., San Angelo, TX (US)

(21) Appl. No.: 12/341,063

(22) Filed: Dec. 22, 2008

(51) Int. Cl. E05C 19/10

(52) U.S. Cl. 292/126

(57) ABSTRACT

An adjustable gate latch assembly for a fence gate is adapted to close against a fence post. The gate latch assembly includes a gate latch body including an extended plate section and a cantilever plate section joined by a curved intermediate section. At least part of the curved intermediate section is corrugated. The cantilever plate section extends at a second angle from a second edge of the curved intermediate section. The curved intermediate section is adapted to receive a fence gate pipe. A latch clamp includes a plurality of curved protruberants at a first end and an opening proximate to a second end. At least a part of the latch clamp is corrugated. A plurality of adjustment slots are formed on the extended plate section to selectively receive the curved protruberants to anchor the first end of the latch clamp to the extended plate section. An opening is formed on the cantilever plate section. A bolt extends through the openings of the latch clamp and the cantilever plate section is secured by a nut to cause the latch clamp to engage the fence gate pipe to enable the gate latch body and the latch clamp to hold the fence gate pipe.

### FIELD OF THE INVENTION

The invention relates to latching mechanisms and, more particularly to an adjustable gate latch assembly for a fence gate adapted to close against a fence post.

### BACKGROUND OF THE INVENTION

A gate latch provides a simple method for securing a fence gate to a fence post. The gate latch also allows the gate to be opened with minimal effort. The gate latch is often used in fenced areas to prevent unwanted openings of the gate.

A gate latch typically includes a main gate latch body that is mounted on a gate pipe and a receiver that is mounted on a fence post. When the gate is closed against the fence, the gate latch body latches onto the receiver, thus securing the gate to the fence. A gate latch assembly typically provides an easy method to open the gate by unlatching the gate latch body from the receiver. The gate latch body may, for example, include gravity latches or drop latches for unlatching or detaching the gate latch body from the receiver in order to conveniently open the gate.

Currently, there are various types of gate latches available. Some gate latches are suitable for round pipes while some are suitable for square pipes. Also, a gate latch is typically designed for a pipe of specific diameter or size. For example, a gate latch designed for a 1.660 inches diameter pipe is unsuitable for a 2.375 inches diameter pipe. If a gate latch designed for a 1.660 inches diameter pipe is mounted on a 2.375 inches diameter pipe, the gate latch would not fit properly due to design constraints.

### SUMMARY OF THE INVENTION

An adjustable gate latch assembly for a fence gate is adapted to close against a fence post. The gate latch assembly includes a gate latch body including an extended plate section and a cantilever plate section joined by a curved intermediate section. At least part of the curved intermediate section is corrugated. The extended plate section extends at a first angle from a first edge of the curved intermediate section. The cantilever plate section extends at a second angle from a second edge of the curved intermediate section. The curved intermediate section is adapted to receive a fence gate pipe.

A latch clamp includes a plurality of curved protruberants at a first end and an opening proximate to a second end. At least a part of the latch clamp is corrugated. A plurality of adjustment slots are formed on the extended plate section to selectively receive the curved protruberants to anchor the first end of the latch clamp to the extended plate section. An opening is formed on the cantilever plate section. A bolt extends through the openings of the latch clamp and the cantilever plate section is secured by a nut to cause the latch clamp to engage the fence gate pipe to enable the gate latch body and the latch clamp to hold the fence gate pipe.

A striker pin is attached to a back side of the curved intermediate section. The striker pin is adapted to slide on a cover ramp of a receiver assembly to push up one of a pair of drop latches. The receiver assembly is mounted on the fence post. The striker pin is held centered on the cover ramp between the pair of drop latches in their released position to cause the fence gate to remain closed against the fence post. A first lock plate is attached to the back side of the curved intermediate section. The first lock plate has a hole adapted to be aligned to a hole of a second lock plate of the receiver assembly to enable a padlock to be placed through the holes to lock the fence gate.

### BRIEF DESCRIPTION OF THE DRAWINGS

For a more complete understanding of the features, example embodiments and possible advantages of the present invention, reference is now made to the detailed description of the invention along with the accompanying figures and in which:

FIGS. 1A-11E illustrate an adjustable gate latch body in accordance with an example embodiment;

FIGS. 2A and 2B show a gate latch body;

FIGS. 3A and 3B show a latch clamp;

FIG. 4 shows a receiver assembly;

FIG. 5 shows a lock plate; and

FIG. 6 shows a drop latch.

### DETAILED DESCRIPTION OF THE INVENTION

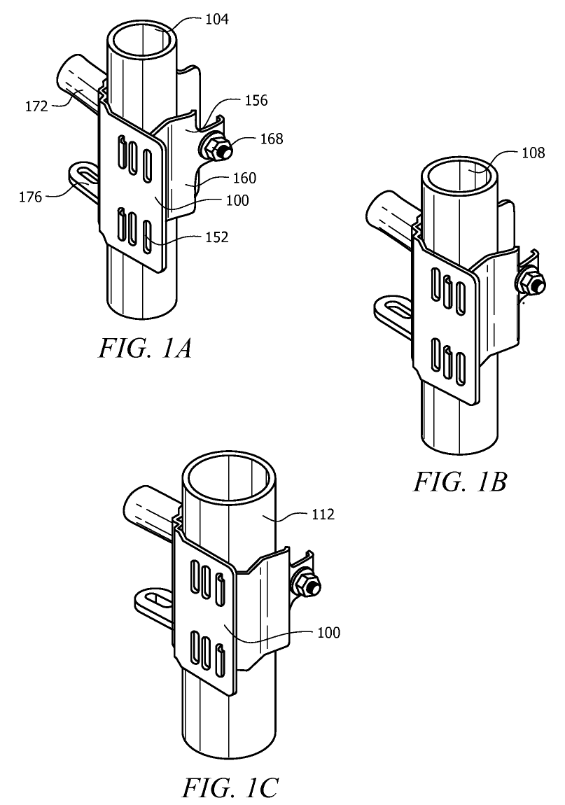

FIGS. 1A-11E illustrate an adjustable gate latch body 100 in accordance with an example embodiment. The adjustable gate latch body 100 comprises one part of the adjustable gate latch assembly for a fence gate. The gate latch body 100 in adapted to be installed or mounted on a fence gate that closes against a fence post. In particular, the gate latch body 100 is mounted on a pipe of a fence gate.

FIGS. 1A-1C illustrate the adjustable gate latch body 100 being mounted on a round pipe of different diameter. In particular, FIGS. 1A, 1B and 1C show the adjustable latch body 100 being mounted on round pipes 104, 108, and 112 having diameters of 1.66 inches, 1.90 inches, and 2.375 inches, respectively. FIGS. 1D and 1E show the adjustable latch body 100 being mounted on square pipes 116 and 120 having dimension (i.e., side length) of 1.5 inches and 2.0 inches, respectively. It will be appreciated that the adjustable gate latch body 100 is adapted to be used with pipes of varying size and shapes (e.g., round pipe, square pipe).

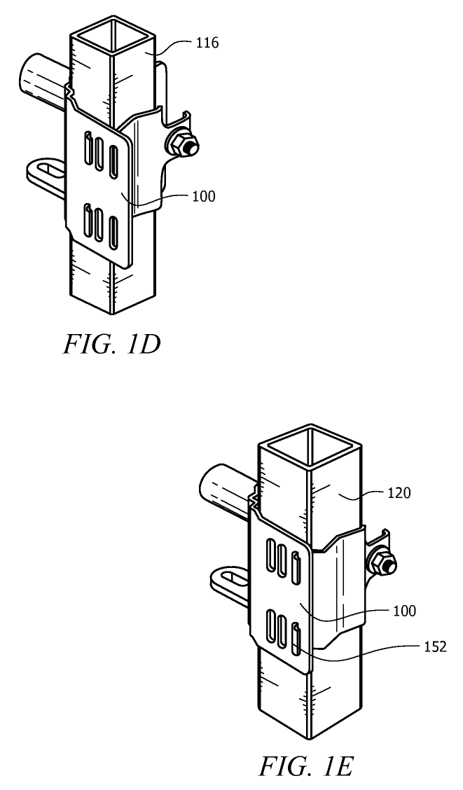

Referring now to FIG. 2A, the gate latch body 100 includes an extended plate section 140 and a cantilever plate section 144 joined by a curved intermediate section 148. The curved intermediate section 148 in one implementation is C-shaped having a front side (also referred to as concave side) and a back side (also referred to as convex side).

In one implementation, the extended plate section 140, the cantilever plate section 144 and the curved intermediate section 148 are formed by bending and shaping a plate. As a further illustration, FIG. 2A is the gate latch body 100 including the extended plate section 140, the cantilever plate section 144 and the curved intermediate section 148. As will be appreciated from FIG. 2A, a single plate is bent and shaped to form the piece comprising the extended plate section 140, the cantilever plate section 144 and the curved intermediate section 148.

As shown in FIG. 2A, at least a portion of the curved intermediate section 148 is corrugated, which allows the curved intermediate section 148 to wrap around a round pipe or a square pipe of different sizes. In one embodiment, at least a portion of the curved intermediate section 148 is shaped like stair-case, i.e., comprising a series of steps, thus enabling the curved intermediate section 148 to accommodate either a round pipe or a square pipe.

As shown in FIG. 2A thee extended plate section 140 extends at a first angle from a first edge of the curved intermediate section 148. In one embodiment, the extended plate section 140 extends substantially tangentially from the first edge of the curved intermediate section 148.

The cantilever plate section 144 extends at a second angle from a second edge of the curved intermediate section 148. In one embodiment, cantilever plate section 144 extends substantially perpendicularly from the second edge of the curved intermediate section 148.

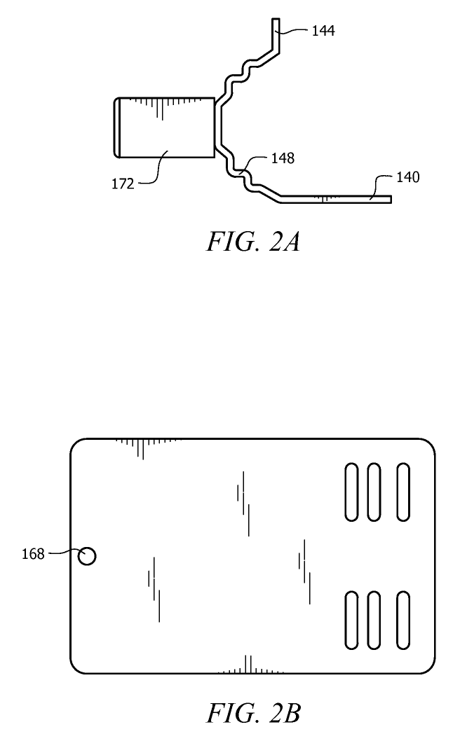

The gate latch body 100 includes a latch clamp 156 having a plurality of curved protruberants 160 (shown in FIG. 1A and FIGS. 3A and 3B) at a first end and an opening 164 proximate to a second end. As shown in FIG. 3A, at least a part of the latch clamp 156 is corrugated, which allows the latch clamp 156 and the gate latch body 100 to hold a pipe securely. In one embodiment, the curved protruberants 160 may be hook-shaped, which allows the latch clamp 156 to be anchored to the extended plate section 140 at one end.

The extended plate section 140 includes a plurality of adjustment slots 152 for selectively receiving the curved protruberants 160 to anchor the first end of the latch clamp 156 to the extended plate section 140. The adjustment slots 152 are selected based on the diameter or the width of the pipe. For example, FIG. 1A shows three pairs of adjustment slots 152 arranged in two rows. A pair of adjustment slots 152 is selected depending on the size of the pipe. For example, the innermost pair of adjustment slots 152 may be selected for round pipe having a diameter of 1.66 inches, while the outermost pair of adjustment slots 152 may be selected for a round pipe having a diameter of 2.375 inches.

The latch clamp 156 includes an opening 164 shown in FIG. 3B. An opening 168 shown in FIG. 2B is also provided in the cantilever plate section 144 of the gate latch body 100. A bolt 168 extending through the openings of the latch clamp 156 and the cantilever plate section 144 is secured by a nut to cause the latch clamp 156 to engage the fence gate pipe and to enable the gate latch body 100 and the latch clamp 156 to hold the fence gate pipe.

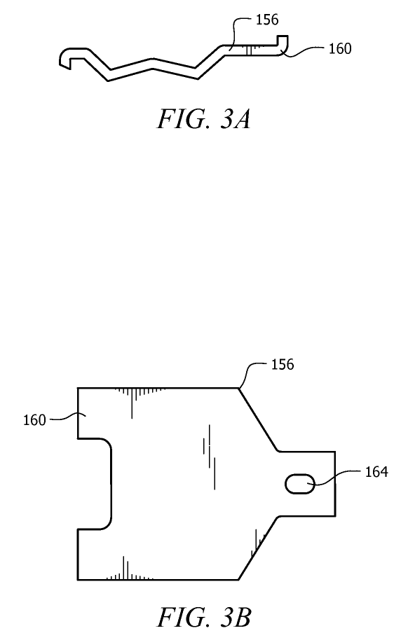

A striker pin 172 shown in FIGS. 1 and 2A is attached to a back side of the curved intermediate section 148. The striker pin 172 is adapted to slide on a cover ramp 404 of a receiver assembly 400 illustrated in FIG. 4. As will be appreciated, the receiver assembly 400 is mounted on a fence post. As the gate is closed against the fence post, the striker pin 172 pushes up one of a pair of drop latches 408 and slides between the two drop latches 408. When the striker pin 172 is centered on the cover ramp 404, the drop latch 408 drops to its released position, whereby the striker pin 172 is trapped between the two drop latches 408 in their released positions. Unless one of the drop latches 408 is pulled up, the catch remains trapped between the two drop latches 408, thus preventing fence gate from opening.

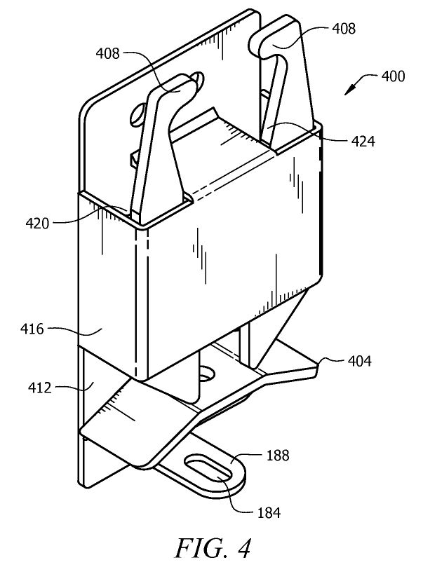

A lock plate 176 (shown in FIGS. 1A and 5) is attached to the back side (i.e., convex side) of the curved intermediate section 148. The lock plate 176 includes a hole 180 adapted to be aligned to a hole 184 of a lock plate 188 (shown in FIG. 4) of the receiver assembly 400 to enable a padlock to be placed through the holes 180 and 184 to lock the fence gate.

Referring now to FIG. 4, the receiver assembly 400 comprises a catch mount 412 including a back plate mounted on the fence post. A drop latch bracket 416 is mounted on the catch mount 412. The drop latch bracket 416 has two interior channels 420 and 424. The drop latches are each slidably retained within a respective one of the interior channels 420 and 424.

The cover ramp 404 is mounted on the catch mount 412 proximate to the drop latch bracket 416. The cover ramp 404 forms a barrier to restrict the length the drop latches 408 can slide. As discussed before, the cover ramp 404 enables the striker pin 172 to slide over to push up one of the drop latches 408. The striker pin 172 is held centered on the cover ramp between the pair of drop latches 408 in their released position. As will be appreciated, when the catch pin 172 is centered on the cover ramp 404, the drop latches 408 drop to their released position, thus trapping the striker pin 172 between the drop latches, which causes the fence gate to remain closed against the fence post.

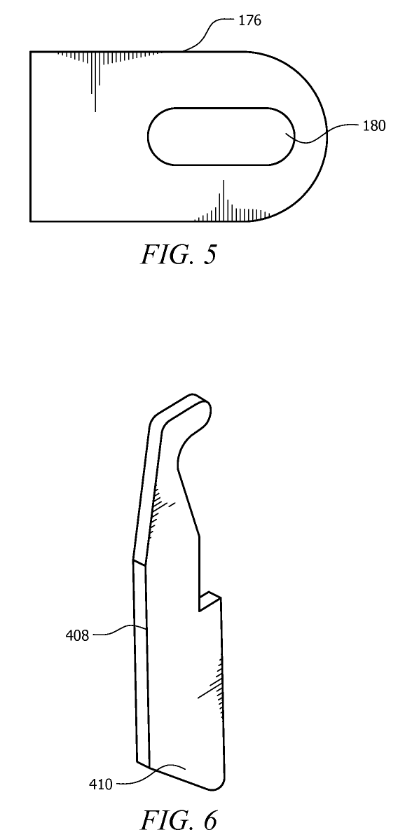

The edge of the drop latch 408 that comes in contact with the striker pin 172 is angular-shaped, which causes the drop latch 408 to be pushed up as the catch pin is forced against the drop latch 408. FIG. 6 shows a drop latch 408 including the angular-shaped edge 410 that comes in contact with the striker pin 172 as the striker pin 172 pushes against the drop latch 408 forcing the drop latch 408 to slide up within the interior channel 420 or 424.

During installation, the latch clamp 156 is detached and removed from the gate latch body 100. Next, the gate latch body 100 is positioned around the gate fence pipe and the latch clamp 156 is attached to the gate latch body 100 by inserting the curved protruberants 160 into a selected pair of adjustment slots 152. As discussed before, the depending on the size of the pipe (i.e., diameter, side length), a pair of adjustment slots is selected. After one end of the latch clamp 156 is anchored to the adjustment slots 152, the latch clamp 156 is attached to the cantilever plate section 144 via a bolt and a nut. As discussed before, the bolt extends through the holes 164 and 168 to cause the gate latch body 100 and the latch clamp to tightly secure the pipe. After the gate latch body 100 is mounted on the gate fence, the receiver 400 is mounted on the fence post so that striker pin 172 is centered between the drop latches 408 when the gate is closed against the fence. Also, when the gate is closed against the fence, the holes 184 and 180 are aligned, thus permitting a padlock to extend through the holes to lock the gate, if necessary.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. An adjustable gate latch assembly for a fence gate adapted to close against a fence post, comprising:
a gate latch body including an extended plate section and a cantilever plate section joined by a curved intermediate section, at least part of the curved intermediate section being corrugated, the extended plate section extending at a first angle from a first edge of the curved intermediate section, the cantilever plate section extending at a second angle from a second edge of the curved intermediate section, the curved intermediate section adapted to receive a fence gate pipe;
a latch clamp having a plurality of curved protruberants at a first end and an opening proximate to a second end, at least a part of the latch clamp being corrugated;
a plurality of adjustment slots on the extended plate section to selectively receive the curved protruberants to anchor the first end of the latch clamp to the extended plate section;
an opening on the cantilever plate section, wherein a bolt extending through the openings of the latch clamp and the cantilever plate section is secured by a nut to cause the latch clamp to engage the fence gate pipe to enable the gate latch body and the latch clamp to hold the fence gate pipe;
a striker pin attached to a back side of the curved intermediate section, the striker pin adapted to slide on a cover ramp of a receiver assembly to push up one of a pair of drop latches, the receiver assembly being mounted on the fence post, the striker pin being held centered on the cover ramp between the pair of drop latches in their released position to cause the fence gate to remain closed against the fence post;
a lock plate attached to the back side of the curved intermediate section, the lock plate having a hole adapted to be aligned to a hole of a lock plate of the receiver assembly to enable a padlock to be placed through the holes to lock the fence gate.

2. The adjustable gate latch assembly of claim 1, wherein the curved intermediate section is C-shaped.

3. The adjustable gate latch assembly of claim 1, wherein the corrugated curved intermediate section is adapted to receive a round pipe.

4. The adjustable gate latch assembly of claim 1, wherein the corrugated curved intermediate section is adapted to receive a square pipe.

5. The adjustable gate latch assembly of claim 1, wherein the curved protruberants are selectively anchored to adjustment slots depending on the diameter of the fence gate pipe.

6. The adjustable gate latch assembly of claim 1, wherein the curved protruberants are selectively anchored to the adjustment slots depending on the cross-sectional area of the pipe.

7. The adjustable gate latch assembly of claim 1, wherein the corrugated curved intermediate section enables the gate latch body to accommodate a square or a round fence gate pipe of varying size.

8. The adjustable gate latch assembly of claim 1, wherein the receiver assembly comprises:
a catch mount including a back plate mounted on the fence post;
a drop latch bracket mounted on the catch mount, the drop latch bracket having two channels;
the drop latches each slidably retained within a respective one of the channels;
the cover ramp mounted on the catch mount proximate to the drop latch bracket, the cover ramp forming a barrier to restrict the length the drop latches can slide, the cover ramp enabling the striker pin to slide over to push up one of the drop latches, the striker pin being held centered on the cover ramp between the pair of drop latches in their released position to cause the fence gate to remain closed against the fence post.

9. The adjustable gate latch assembly of claim 8, wherein the edge of the drop latch is angular-shaped to cause the drop latch to slide up when pushed by the striker pin.

10. An adjustable gate latch assembly for securing a swinging fence gate to a fence post, comprising:
a gate latch body including an extended plate section and a cantilever plate section joined by a curved intermediate section, at least part of the curved intermediate section being corrugated, the extended plate section extending at a first angle from a first edge of the curved intermediate section, the cantilever plate section extending at a second angle from a second edge of the curved intermediate section, the curved intermediate section adapted to receive the fence gate pipe;
a latch clamp having a plurality of curved protruberants at a first end and an opening proximate to a second end, at least a part of the latch clamp being corrugated;
a plurality of adjustment slots on the extended plate section to selectively receive the curved protruberants to anchor the first end of the latch clamp to the extended plate section;
an opening on the cantilever plate section, wherein a bolt extending through the openings of the latch clamp and the cantilever plate section is secured by a nut to cause the latch clamp to engage the fence gate pipe to enable the gate latch body and the latch clamp to hold the fence gate pipe;
a striker pin attached to a back side of the curved intermediate section, the striker pin adapted to slide on a cover ramp of a receiver assembly to push up one of a pair of drop latches, the receiver assembly being mounted on the fence post, the catch pin being held centered on the cover ramp between the pair of drop latches in their released position to cause the fence gate to remain closed against the fence post;
a lock plate attached to the back side of the curved intermediate section, the lock plate having a hole adapted to be aligned to a hole of a lock plate of the receiver assembly to enable a padlock to be placed through the holes to lock the fence gate,
the receiver assembly comprising:
a catch mount including a back plate mounted on the fence post;
a drop latch bracket mounted on the catch mount, the drop latch bracket having two channels;
the drop latches each slidably retained within a respective one of the channels;
the cover ramp mounted on the catch mount proximate to the drop latch bracket, the cover ramp forming a barrier to restrict the length the drop latches can slide, the cover ramp enabling the striker pin to slide over to push up one of the drop latches, the striker pin being held centered on the cover ramp between the pair of drop latches in their released position to cause the fence gate to remain closed against the fence post.

11. The adjustable gate latch assembly of claim 10, wherein the edge of the drop latch is angular-shaped to cause the drop latch to slide when pushed up by the striker pin.

12. The adjustable gate latch assembly of claim 10, wherein the curved intermediate section is C-shaped.

13. The adjustable gate latch assembly of claim 10, wherein the corrugated curved intermediate section is adapted to receive a round pipe.

14. The adjustable gate latch assembly of claim 10, wherein the corrugated curved intermediate section is adapted to receive a square pipe.

15. The adjustable gate latch assembly of claim 10, wherein the curved protruberants are selectively anchored to adjustment slots depending on the diameter of the fence gate pipe.

16. The adjustable gate latch assembly of claim 10, wherein the curved protruberants are selectively anchored to the adjustment slots depending on the cross-sectional area of the pipe.

17. The adjustable gate latch assembly of claim 10, wherein the corrugated curved intermediate section enables the gate latch body to accommodate a square or a round fence gate pipe of varying size.

18. The adjustable gate latch assembly of claim 10, wherein the edge of the drop latch is angular-shaped to cause the drop latch to slide when pushed up by the striker pin.

19. An adjustable gate latch assembly for a fence gate adapted to close against a fence post, comprising:
a gate latch body adapted to be mounted on a fence pipe, the gate latch body including an extended plate section and a cantilever plate section joined by a C-shaped intermediate section, at least part of the intermediate section being corrugated, the extended plate section extending substantially tangentially from a first edge of the intermediate section, the cantilever plate section extending substantially perpendicularly from a second edge of the intermediate section, the intermediate section adapted to receive the fence gate pipe;
a latch clamp having a plurality of hooked protruberants at a first end and an opening proximate to a second end, at least a part of the latch clamp being corrugated;
a plurality of adjustment slots on the extended plate section to selectively receive the hooked protruberants to anchor the first end of the latch clamp to the extended plate section;
an opening on the cantilever plate section, wherein a bolt extending through the openings of the latch clamp and the cantilever plate section is secured by a nut to cause the latch clamp to engage the fence gate pipe to enable the gate latch body and the latch clamp to hold the fence gate pipe;
a striker pin attached to a back side of the intermediate section, the catch pin adapted to slide on a cover ramp of a receiver assembly to push up one of a pair of drop latches, the receiver assembly being mounted on the fence post, the striker pin being held centered on the cover ramp between the pair of drop latches in their released position to cause the fence gate to remain closed against the fence post;
a lock plate attached to the back side of the intermediate section, the lock plate having a hole adapted to be aligned to a hole of a lock plate of the receiver assembly to enable a padlock to be placed through the holes to lock the fence gate.

20. The adjustable gate latch assembly of claim 19, wherein the corrugated intermediate section is adapted to receive a round or a square pipe.

21. The adjustable gate latch assembly of claim 19, wherein the hooked protruberants are selectively anchored to adjustment slots depending on the diameter of the fence gate pipe.

22. The adjustable gate latch assembly of claim 19, wherein the hooked protruberants are selectively anchored to the adjustment slots depending on the cross-sectional area of the pipe.

23. The adjustable gate latch assembly of claim 19, wherein the corrugated intermediate section enables the gate latch body to accommodate a square or a round fence gate pipe of varying size.
